(19) United States
(12) Patent Application Publication
(10) Pub. No.: US 2016/0248459 A1
(43) Pub. Date: Aug. 25, 2016

(54) SYSTEMS AND METHODS FOR AUTOMATIC GAIN CONTROL USING A CARRIER ESTIMATION PATH

(71) Applicant: QUALCOMM Incorporated, San Diego, CA (US)

(72) Inventors: Haitao Gan, Santa Clara, CA (US); Angelica Wong, Palo Alto, CA (US)

(21) Appl. No.: 14/626,655

(22) Filed: Feb. 19, 2015

(51) Int. Cl. H04B 1/10; H04B 5/00

(52) U.S. Cl. CPC H04B 1/109; H04B 1/1027; H04B 5/0025

(57) ABSTRACT

A method is described. The method includes receiving a carrier signal by a communication device. The method also includes determining a carrier level estimation of the carrier signal using a carrier estimation path. The method further includes adjusting an attenuation and/or receiver path gain based on the carrier level estimation. The communication device may be an initiator near field communication (NFC) device.

### TECHNICAL FIELD

The present disclosure relates generally to wireless communications. More specifically, the present disclosure relates to automatic gain control (AGC) using a carrier estimation path by a near field communication (NFC) device.

### BACKGROUND

Advances in technology have resulted in smaller and more powerful personal computing devices. For example, there currently exist a variety of portable personal computing devices, including wireless computing devices, such as portable wireless telephones, personal digital assistants (PDAs) and paging devices that are each small, lightweight, and can be easily carried by users. More specifically, the portable wireless telephones, for example, further include cellular telephones that communicate voice and data packets over wireless networks. Many such cellular telephones are being manufactured with relatively large increases in computing capabilities, and as such, are becoming tantamount to small personal computers and hand-held PDAs. Further, such devices are being manufactured to enable communications using a variety of frequencies and applicable coverage areas, such as cellular communications, wireless local area network (WLAN) communications, near field communication (NFC), etc.

When NFC is implemented, an NFC enabled device may receive signals from another NFC device. The carrier level of the signals may affect the quality of the communication. Therefore, benefits may be realized performing automatic gain control using a carrier estimation path.

### SUMMARY

A method is described. The method includes determining a carrier level estimation of a carrier signal received by a communication device using a carrier estimation path. The method also includes adjusting an attenuation based on the carrier level estimation.

The method may also include adjusting at least one of a band-pass filter gain and a low-pass filter gain based on the carrier level estimation.

The communication device may be an initiator near field communication (NFC) device. The carrier estimation path may be included in a receiver. The carrier estimation path may preserve the carrier signal by bypassing a band-pass filter. The carrier level estimation may be determined during a continuous wave period.

Determining the carrier level estimation may include enabling the carrier estimation path. The carrier signal may be received at the carrier estimation path. The carrier signal may be converted to a DC level. The DC level may include an in-phase component and a quadrature-phase component. The DC level may be measured.

The method may also include determining an automatic gain control (AGC) gain table based on the carrier level estimation. Determining the AGC gain table may include applying a range of attenuation values. An attenuator gain may be determined for each attenuation value based on the carrier level estimation. Attenuation values may be selected to produce nominal steps within an attenuation gain range. The selected attenuation values may be assigned to index numbers of the AGC gain table.

Adjusting the attenuation may include determining a baseband signal amplitude based on the carrier level estimation. Whether to reduce the attenuation may be determined based on whether the baseband signal amplitude is less than a target value.

Adjusting the attenuation may also include applying a maximum attenuation during a continuous wave period. The baseband signal amplitude may be determined based on the carrier level estimation and the maximum attenuation. The baseband signal amplitude may be determined to be less than a target value. The attenuation may be reduced to bring the baseband signal amplitude within a threshold of the target value.

An electronic device is also described. The electronic device includes a processor, memory in electronic communication with the processor and instructions stored in the memory. The instructions are executable by the processor to determine a carrier level estimation of a carrier signal received by the electronic device using a carrier estimation path. The instructions are also executable to adjust at least one of an attenuation, a band-pass filter gain and a low-pass filter gain based on the carrier level estimation.

A computer-program product is also described. The computer-program product includes a non-transitory computer-readable medium having instructions thereon. The instructions include code for causing an electronic device to determine a carrier level estimation of a carrier signal received by the electronic device using a carrier estimation path. The instructions also include code for causing the electronic device to adjust at least one of an attenuation, a band-pass filter gain and a low-pass filter gain based on the carrier level estimation.

### BRIEF DESCRIPTION OF THE DRAWINGS

FIG. 1 is a block diagram illustrating one configuration of a wireless communication system;

FIG. 2 is a flow diagram illustrating a method for automatic gain control (AGC) using a carrier estimation path;

FIG. 3 is a block diagram illustrating one configuration of an initiator receiver;

FIG. 4 is a flow diagram illustrating a method for determining an AGC gain table using a carrier estimation path;

FIG. 5 is a flow diagram illustrating a detailed method for determining an AGC gain table using a carrier estimation path;

FIG. 6 is a flow diagram illustrating a method for dynamically adjusting attenuation using a carrier estimation path;

FIG. 7 is a flow diagram illustrating a detailed method for dynamically adjusting attenuation using a carrier estimation path; and

FIG. 8 illustrates certain components that may be included within an electronic device.

### DETAILED DESCRIPTION

It should be noted that some communication devices may communicate wirelessly and/or may communicate using a wired connection or link. For example, some communication devices may communicate with other devices using an Ethernet protocol. The systems and methods disclosed herein may be applied to communication devices that communicate wirelessly and/or that communicate using a wired connection or link. In one configuration, the systems and methods disclosed herein may be applied to a communication device that communicates with another device using near field communication (NFC).

As described herein, an initiator NFC device may recognize a target NFC device and/or tag when within range of the coverage area of the NFC device and/or tag. The term NFC tag refers to an integrated circuit that provides NFC functionality. After a target NFC device and/or tag have been located, the initiator NFC device may obtain sufficient information to allow for communications to be established. Communications between the devices may be enabled over a variety of NFC RF technologies, such as, but not limited to, NFC-A, NFC-B, NFC-F, etc.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

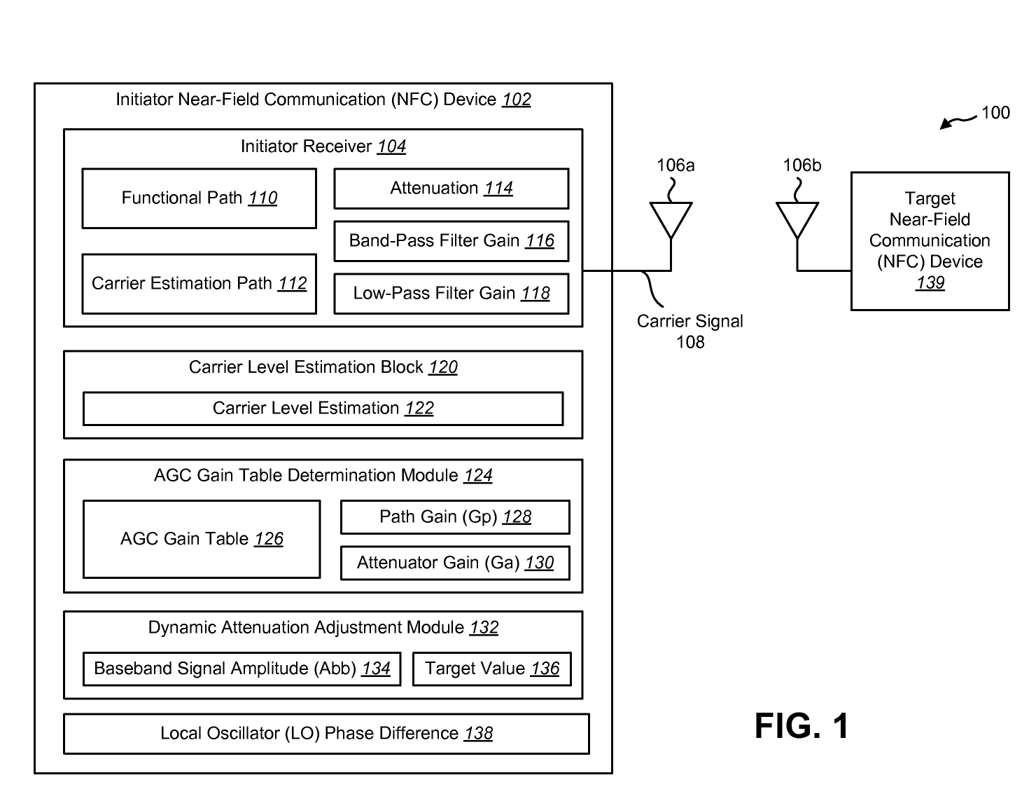

FIG. 1 is a block diagram illustrating one configuration of a wireless communication system 100. The wireless communication system 100 may include an initiator NFC device 102. The initiator NFC device 102 may communicate with a target NFC device 139. The initiator NFC device 102 may also be referred to as a poller, polling device or initiator. The target NFC device 139 may also be referred to as a listener, listening device or target.

NFC is an inductively coupled communication. Therefore, the initiator NFC device 102 may also be referred to as an inductively coupled communication device. The antenna 106a of the initiator NFC device 102 produces a radiated field (also referred to as a magnetic field or an electromagnetic field) that is received by the antenna 106b of the target NFC device 139.

The initiator NFC device 102 and the target NFC device 139 may use one or more NFC signaling technologies to communicate with each other. The NFC signaling technologies may include NFC-A, NFC-B and NFC-F. NFC-A may be referred to as type-A, NFC-B may be referred to as type-B and NFC-F may be referred to as type-F. The NFC signaling technologies differ in the modulation schemes employed.

NFC has four different tag types, which support a subset of the NFC signaling technologies. Type 1 tags (T1T) use NFC-A communication without data collision protection. Type 2 tags (T2T) use NFC-B communication with anti-collision. Type 3 tags (T3T) use NFC-F with anti-collision. Type 4 tags (T4T) can use either NFC-A (T4AT) or NFC-B (T4BT) with anti-collision.

In one configuration, the initiator NFC device 102 and the target NFC device 139 may be operable to communicate using NFC through various interfaces, such as a frame radio frequency (RF) interface, ISO-data exchange protocol (DEP) RF interface and NFC-DEP RF interface. In another configuration, the initiator NFC device 102 and the target NFC device 139 may establish an NFC-DEP RF protocol based communication link with link layer connections defined through a logical link control protocol (LLCP). In still another configuration, the initiator NFC device 102 and the target NFC device 139 may be operable to be connected to an access network and/or core network (e.g., a CDMA network, a GPRS network, a UMTS network, and other types of wireline and wireless communication networks).

The initiator NFC device 102 may poll for nearby NFC devices. The target NFC device 139 may begin to listen when it comes within a few centimeters of the initiator NFC device 102. The initiator NFC device 102 will then communicate with the target NFC device 139 in order to determine which signaling technologies can be used. In one case, the initiator NFC device 102 may be acting as a reader. In other words, the initiator NFC device 102 may be in a reader mode. In this case, a user may place a target NFC device 139 in the vicinity of the initiator NFC device 102 to initiate a payment transaction.

The initiator NFC device 102 may generate an RF field to communicate with the target NFC device 139. The initiator NFC device 102 may modulate the RF field to send a signal (e.g., data) to the target NFC device 139. Once the target NFC device 139 receives that signal, the initiator NFC device 102 may transmit a continuous wave to maintain the RF field. The continuous wave may have a carrier frequency. In the case of NFC, the carrier frequency may be 13.56 megahertz (MHz).

The target NFC device 139 may receive the RF field. The target NFC device 139 may respond by performing modulation on top of the continuous wave. The initiator NFC device 102 may receive the modulated signal and may try to decode it.

In summary, during a first communication period, the initiator NFC device 102 may transmit data to the target NFC device 139. In the first communication period, the initiator NFC device 102 is in an initiator transmit (TX) mode. During a second communication period, the target NFC device 139 may respond back. In the second communication period, the initiator NFC device 102 is in an initiator receive (RX) mode.

A continuous wave period may be the period of time when the initiator NFC device 102 starts generating the continuous wave and before the target NFC device 139 modulates the continuous wave. During the continuous wave period, the initiator NFC device 102 may receive a carrier signal 108 of the continuous wave at an initiator receiver 104. In other words, the initiator NFC device 102 may receive the carrier signal 108 that it transmits in the continuous wave. The strength of the carrier signal 108 is referred to as the carrier level of the carrier signal 108. The carrier level may be measured at a particular point in a radio path.

With different antenna 106 configurations, the carrier level of the carrier signal 108 may vary. In one case, the initiator NFC device 102 and the target NFC device 139 may have different antennas 106. The antennas 106 may have different dimensions or sizes. This may occur when the initiator NFC device 102 and the target NFC device 139 are made by different manufacturers or are different models made by the same manufacturer. Differences in antenna 106 dimensions may result in large variations of the carrier level.

In another case, the carrier level may vary due to the motion of the initiator NFC device 102 or the target NFC device 139. In this case, even if the antennas 106 are the same, different distances between the initiator NFC device 102 antenna 106a and the target NFC device 139 antenna 106b may result in large variations of the carrier level. In one scenario, the initiator NFC device 102 and the target NFC device 139 may be at a far distance, which results in a large carrier level and small modulation index. In another scenario, as the initiator NFC device 102 and the target NFC device 139 are brought closer, the carrier level goes down and modulation index goes up. In either scenario, the carrier level may be higher than the initiator NFC device 102 can handle without proper attenuation.

If the carrier level is too high, the initiator receiver 104 may become saturated. The initiator NFC device 102 may perform automatic gain control (AGC) on the received signal. In one approach, the initiator NFC device 102 may set the attenuation 114 of the carrier signal 108 to handle the highest carrier level. However, this approach may result in unnecessary attenuation of the carrier signal 108 and sideband signal, which may degrade sideband signal to noise ratio. Therefore, benefits may be realized by estimating the carrier level and performing AGC based on the carrier level estimation 122. The AGC may include adjusting one or more of an attenuation 114, band-pass filter (BPF) gain 116 and low-pass filter (LPF) gain 118 for the initiator receiver 104.

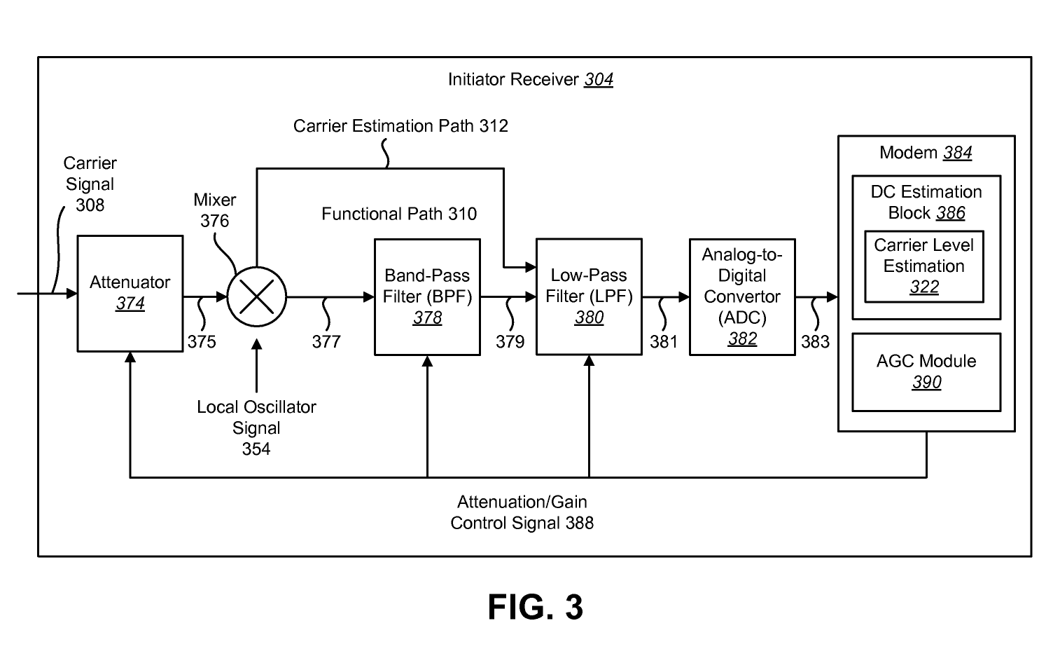

The initiator receiver 104 may include a functional path 110. Components that may be included in the functional path 110 may include an attenuator, mixer, band-pass filter (BPF), low-pass filter (LPF), analog-to-digital converter (ADC) and modem. One configuration of an initiator receiver 104 is illustrated in FIG. 3. During normal operation (e.g., non-carrier level estimation operation), the carrier signal 108 is processed using the functional path 110. As part of the signal processing on the functional path 110, the carrier signal 108 may be filtered by the BPF.

To determine the carrier level estimation 122, the initiator receiver 104 may include a carrier estimation path 112. The carrier estimation path 112 may preserve the carrier signal 108 by bypassing the BPF. The initiator NFC device 102 may activate (e.g., enable) the carrier estimation path 112 during a continuous wave period. During the continuous wave period, the carrier signal 108 may be received at the carrier estimation path 112. A carrier level estimation block 120 may then obtain a carrier level estimation 122.

In one implementation, the initiator NFC device 102 may convert the analog carrier signal 108 to a digital signal that is measured by the carrier level estimation block 120. For example, the initiator NFC device 102 may down-convert the carrier signal 108 to a DC level. After down conversion, the DC level may include an in-phase component and a quadrature-phase component. The DC level may include two channels (e.g., paths). One channel may be an in-phase channel (I_{dc}) and the other channel may be a quadrature-phase channel (Q_{dc}). The DC level of the whole system corresponds to the carrier level. The carrier level estimation block 120 may include a DC estimation block that estimates the carrier level by measuring the DC level.

The initiator NFC device 102 may determine the gain of the functional path 110 using the carrier level estimation 122. The path gain (Gₚ) 128 may be determined according to Equation (1).

Gₚ=−Ac+10·log 10(I_{dc}²+Q_{dc}²) (1)

In Equation (1), Ac is the carrier level in decibels (dB). I_{dc} (e.g., the I-channel) and Q_{dc} (e.g., the Q-channel) may be determined by the carrier estimation block 120.

The initiator NFC device 102 may adjust the attenuation 114 of the initiator receiver 104 based on the carrier level estimation 122. The initiator NFC device 102 may perform different operations using the carrier level estimation 122.

In one case, adjusting the attenuation 114 may include determining an AGC gain table 126 based on the carrier level estimation 122. The AGC gain table 126 may be calibrated during a bench calibration. The AGC gain table 126 may be a lookup table (LUT) that maps different values of attenuation 114, BPF gains 116 and LPF gains 118.

An AGC gain table determination module 124 may determine the AGC gain table 126. The AGC gain table determination module 124 may apply a carrier signal 108 with a known carrier level (Ac). The AGC gain table determination module 124 may then apply a range of attenuation 114 values while keeping the gain of other initiator receiver 104 components fixed.

The AGC gain table determination module 124 may determine the path gain (Gp) 128 for each attenuation 114 value based on the carrier level estimation 122. This may be accomplished according to Equation (1) above. From the path gains 128, the AGC gain table determination module 124 may determine an attenuator gain 130 for each attenuation value. There may be a relatively fixed difference (Δ) between the path gain (Gp) 128 and the attenuator gain (Ga) 130. Therefore, the attenuator gain (Ga) 130 may be determined as Ga=Gp−Δ.

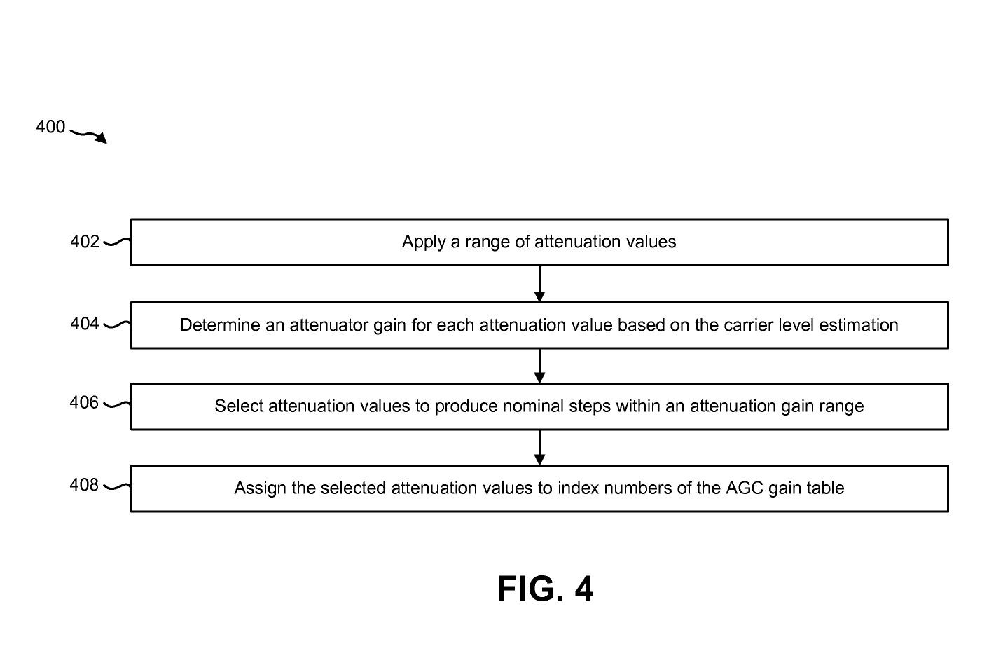

The AGC gain table determination module 124 may select attenuation 114 values to produce nominal steps within an attenuator gain range. The AGC gain table determination module 124 may assign the selected attenuation 114 values to index numbers of the AGC gain table 126. An example of an AGC gain table 126 is described in connection with FIG. 4 below.

In another case, the adjusting the attenuation 114 may include dynamically adjusting the attenuation 114 during normal operation of the initiator receiver 104. For example, a dynamic attenuation adjustment module 132 may adjust the attenuation 114 at various times during operation, including during communication with a target NFC device 139.

In one implementation, the dynamic attenuation adjustment module 132 may determine a baseband signal amplitude (A_{bb}) 134 based on the carrier level estimation 122. This may be accomplished according to Equation (2).

A_{bb}=\sqrt{I_{dc}²+Q_{dc}²} (2)

The dynamic attenuation adjustment module 132 may determine the baseband signal amplitude 134 during a continuous wave period. In one case, the continuous wave period may include the initial initiator transmission of the continuous wave to the target NFC device 139 before the target NFC device 139 modulates the continuous wave. Another continuous wave period may include the transition from initiator transmission to initiator reception.

The dynamic attenuation adjustment module 132 may determine whether to reduce the attenuation 114 based on whether the baseband signal amplitude 134 is less than a target value 136. If the baseband signal amplitude 134 is not less than the target value 136, then the dynamic attenuation adjustment module 132 may not change the attenuation 114. In this case, the carrier signal 108 is neither saturating the initiator receiver 104 nor being excessively attenuated.

If the baseband signal amplitude 134 is much less than the target value 136, then the carrier signal 108 may be attenuated more than necessary. In this case, the dynamic attenuation adjustment module 132 may reduce the attenuation 114 to bring the amplitude of the baseband signal 134 within a threshold of the target value 136.

Upon determining the attenuation 114, the initiator NFC device 102 may adjust at least one of a band-pass filter gain 116 and a low-pass filter gain 118 accordingly. For example, the selected attenuation 114 may be mapped to a band-pass filter gain 116 and a low-pass filter gain 118. In one implementation, this mapping may be provided by the AGC gain table 126. By selecting an attenuation 114, the band-pass filter gain 116 and the low-pass filter gain 118 may be set accordingly.

The described systems and methods may provide design flexibility and improve efficiency. The initiator NFC device 102 may adapt to different tags and its own antenna 106a. For example, the initiator NFC device 102 can move from large to small antenna and calibrate the initiator receiver 104. This makes the initiator NFC device 102 more robust. Furthermore, the described systems and methods will greatly reduce the amount of manual tuning of the initiator NFC device 102.

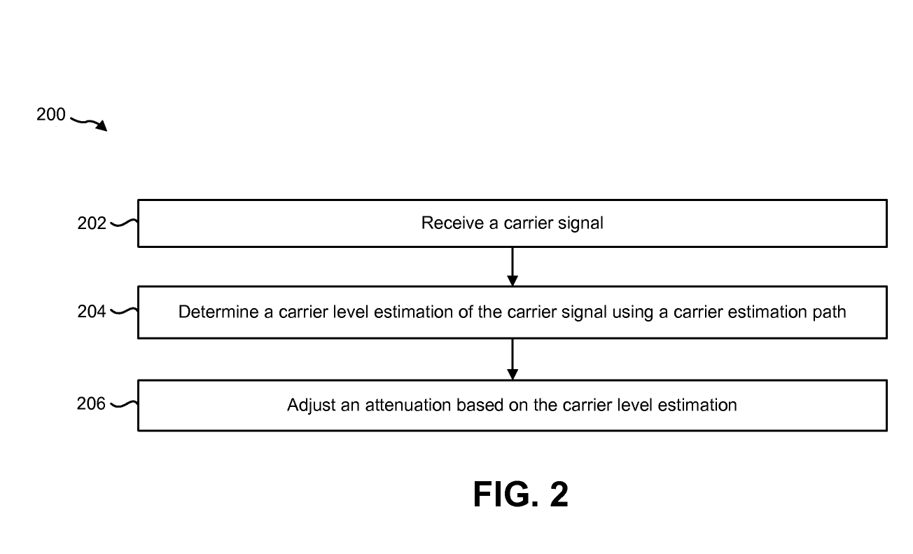

FIG. 2 is a flow diagram illustrating a method 200 for AGC using a carrier estimation path 112. The method 200 may be performed by an initiator NFC device 102. The initiator NFC device 102 may receive 202 a carrier signal 108. During a continuous wave period, the initiator NFC device 102 may receive a carrier signal 108 of the continuous wave. In other words, the initiator NFC device 102 may receive the carrier signal 108 that it transmits in the continuous wave.

The initiator NFC device 102 may determine 204 a carrier level estimation 122 of the carrier signal 108. The carrier level represents the strength of the carrier signal 108 as measured at a particular point in a radio path. The initiator NFC device 102 may activate a carrier estimation path 112 that bypasses a band-pass filter in the initiator receiver 104. A carrier level estimation block 120 may then obtain a carrier level estimation 122.

In one implementation, the initiator NFC device 102 may convert the analog carrier signal 108 to a digital signal to estimate the carrier level. The initiator NFC device 102 may down-convert the carrier signal 108 to a DC level. After down conversion, the DC level may include an in-phase component and a quadrature-phase component. The initiator NFC device 102 may estimate the carrier level by measuring the DC level.

The initiator NFC device 102 may adjust 206 the attenuation 114 of the initiator receiver 104 based on the carrier level estimation 122. The initiator NFC device 102 may perform different operations using the carrier level estimation 122.

In one case, the initiator NFC device 102 may adjust 206 the attenuation 114 to determine an AGC gain table 126 based on the carrier level estimation 122. The initiator NFC device 102 may apply a carrier signal 108 with a known carrier level. The initiator NFC device 102 may then apply a range of attenuation values while keeping the gain of other initiator receiver 104 components fixed.

The initiator NFC device 102 may determine the path gain 128 for each attenuation value based on the carrier level estimation 122. This may be accomplished according to Equation (1) above. From the path gains 128, the initiator NFC device 102 may determine an attenuator gain 130 for each attenuation value. The initiator NFC device 102 may select attenuation 114 values to produce nominal steps within an attenuation gain range and assign the selected attenuation 114 values to index numbers of the AGC gain table 126.

In another case, the initiator NFC device 102 may adjust 206 the attenuation 114 by dynamically adjusting the attenuation 114 during normal operation of the initiator receiver 104. For example, the initiator NFC device 102 may determine a baseband signal amplitude (A_{bb}) 134 based on the carrier level estimation 122. This may be accomplished according to Equation (2) above. The initiator NFC device 102 may determine the baseband signal amplitude 134 during a continuous wave period.

The initiator NFC device 102 may determine whether to reduce the attenuation 114 based on whether the baseband signal amplitude 134 is less than a target value 136. If the baseband signal amplitude 134 is not less than the target value 136, then the initiator NFC device 102 may not change the attenuation 114. If the baseband signal amplitude 134 is less than the target value 136, then initiator NFC device 102 may reduce the attenuation 114 to bring the amplitude of the baseband signal 134 within a threshold of the target value 136.

FIG. 3 is a block diagram illustrating one configuration of an initiator receiver 304. The initiator receiver 304 may be implemented in accordance with the initiator receiver 104 described in connection with FIG. 1.

The initiator receiver 304 may include a functional path 310 that may receive and process a carrier modulated signal 308 during normal operation. An attenuator 374 may attenuate the carrier modulated signal 308 so that the internal circuit can operate on it. The attenuator 374 may be implemented as a capacitive or resistive divider that may change its attenuation 114 based on a control signal. In one configuration, a code may be a register value that controls the attenuator 374 for different attenuation 114. A higher code may produce more attenuation 114.

The mixer 376 may down-convert the attenuated signal 375 to baseband using a local oscillator signal 354. The down-converted signal 377 may be a DC and baseband signal that includes an I-channel and a Q-channel. In the functional path 310, the down-converted signal 377 may then pass through a band-pass filter 378 and a low-pass filter 380 to prepare the baseband signal so the ADC 382 can sample it and convert it to a digital signal 383. The down-converted carrier may be filtered out of the band-pass filtered signal 379, leaving the baseband signal 379. The low-pass filtered signal 381 may be provided to the ADC 382. A modem 384 may receive and process the digital signal 383.

The carrier estimation path 312 may bypass the band-pass filter 378 to preserve the down-converted carrier level in order to tune the gain of the whole path. A low-pass filter 380 may be maintained to provide anti-aliasing filtering for the ADC 382.

For the carrier estimation path 312, the carrier signal 308 is received and down-converted to DC. Therefore, a DC level that reflects the carrier signal 308 strength is received at the ADC 382.

The modem 384 may include a DC estimation block 386 that can process the digital signal 383 to determine a carrier level estimation 322. This may include measuring the in-phase component (e.g., I_{dc}) and the quadrature-phase component (e.g., Q_{dc}) of the DC level.

The modem 384 may also include an AGC module 390 to perform attenuation and gain control based on the carrier level estimation 322. The AGC module 390 may determine an attenuation 114 for the attenuator 374. The AGC module 390 may also determine a BPF gain 116 for the BPF 378 and a LPF gain 118 for the LPF 380. This may be accomplished as described above in connection with FIG. 1.

In one configuration, the BPF gain 116 and the LPF gain 118 may be mapped to attenuation 114 values. Therefore, by determining the attenuation 114, the BPF gain 116 and the LPF gain 118 may be set based on the selected attenuation 114. The AGC module 390 may send one or more attenuation/gain control signals 388 to the attenuator 374, BPF 378 and LPF 380 to adjust their respective attenuation 114 and gain levels.

FIG. 4 is a flow diagram illustrating a method 400 for determining an AGC gain table 126 using a carrier estimation path 112. The method 400 may be performed by an initiator NFC device 102 to calibrate an attenuator 374. The initiator NFC device 102 may receive a carrier signal 108 during a continuous wave period. The carrier signal 108 may be a known carrier level. The initiator NFC device 102 may enable a carrier estimation path 112.

The initiator NFC device 102 may apply 402 a range of attenuation 114 values. Each attenuation 114 value may produce a different amount of attenuation 114 by the attenuator 374. For example, the attenuation values 114 may be a series of attenuation codes that may adjust the capacitance or resistance of the attenuator 374.

The initiator NFC device 102 may determine 404 an attenuator gain 130 for each attenuation value based on the carrier level estimation 122. This may be accomplished by first determining the path gain (Gp) 128 according to Equation (1) above. From the path gain 128, the initiator NFC device 102 may determine an attenuator gain 130 for each attenuation value. The attenuator gain 130 may be a fixed difference (Δ) from the path gain 128. Therefore, the attenuator gain (Ga) 130 may be determined as Ga=Gp−Δ. The initiator NFC device 102 may store the attenuator gains 130 in memory.

The initiator NFC device 102 may select 406 attenuation 114 values to produce nominal steps within an attenuation gain range. The initiator NFC device 102 may assign 408 the selected attenuation 114 values to index numbers of the AGC gain table 126.

In one configuration, the AGC gain table 126 may be a look up table (LUT). In this configuration, the LUT may have index numbers (also referred to as a gain table numbers) with corresponding attenuation codes. An attenuation code may be a register value that controls the attenuator 374 for the different attenuation 114. The attenuation code may also be referred to as attenuator code.

Each index number of the AGC gain table 126 may also have an associated band-pass filter (BPF) code that indicates a BPF gain 116. Similarly, each index number of the AGC gain table 126 may have an associated low pass filter (LPF) code that indicates a LPF gain 118.

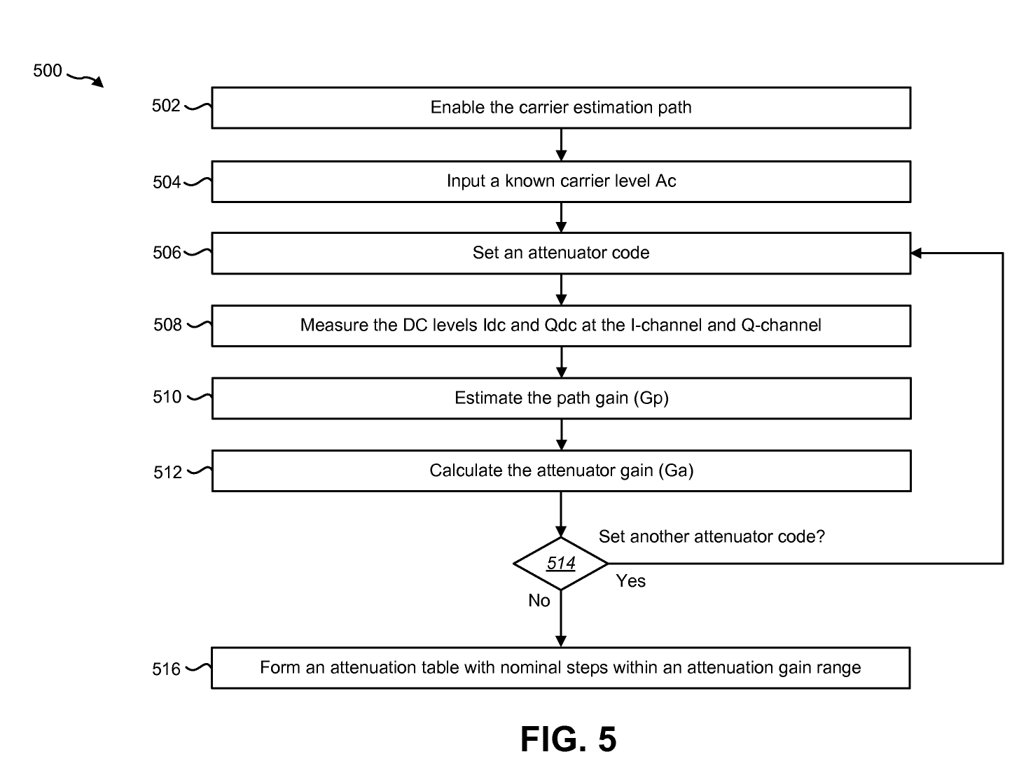

FIG. 5 is a flow diagram illustrating a detailed method 500 for determining an AGC gain table 126 using a carrier estimation path 112. The method 500 may be performed by an initiator NFC device 102.

The initiator NFC device 102 may enable 502 a carrier estimation path 112. The carrier estimation path 112 may preserve a carrier signal 108 by bypassing a band-pass filter 378.

The initiator NFC device 102 may input 504 a known carrier level (Ac) during the calibration process. For example, the carrier level may be 1 Vsp. The input carrier level should not saturate the ADC 382 even with the smallest attenuation 114 (e.g., when an attenuator code=0).

The initiator NFC device 102 may set 506 an attenuator code. The attenuator code may be the amount of attenuation 114 produced by the attenuator 374. The initiator NFC device 102 may apply a range of attenuator codes (e.g., attenuation 114 values). Each attenuator code may produce a different amount of attenuation 114 by the attenuator 374. In one configuration, the attenuator code may be a cap code.

The initiator NFC device 102 may measure 508 the DC levels I_{dc} and Q_{dc} at the I-channel and Q-channel. For example, a DC estimation block 386 may measure the I component and the Q component of the DC level provided by the ADC 382. In one configuration, the initiator NFC device 102 may check the DC offset with no input signal and subtract DC offset from the I_{dc} and Q_{dc}.

The initiator NFC device 102 may estimate 510 the path gain (Gp) 128. This may be accomplished according to Equation (1) using the known carrier level (Ac) and the measured I_{dc} and Q_{dc}.

The initiator NFC device 102 may then calculate 512 the attenuator gain (Ga) 130 from the path gain (Gp) 128. The attenuator gain (Ga) 130 may be determined as Ga=Gp−Δ, where Δ is the fixed difference from the path gain 128.

The initiator NFC device 102 may determine 514 whether to set another attenuator code. Therefore, the initiator NFC device 102 may loop through the range of attenuator codes (from 0 to 255, for example) and determine the associated attenuator gain (Ga) 130 of each attenuator code.

When the initiator NFC device 102 determines 514 to not set another code (e.g., upon exhausting the range of attenuator codes), the initiator NFC device 102 may form 516 an attenuation table with nominal steps within an attenuation gain range. The initiator NFC device 102 may select attenuator codes from the range of attenuator codes to produce the nominal steps within the attenuation gain range. The attenuation table may be included in an AGC gain table 126 (e.g., LUT).

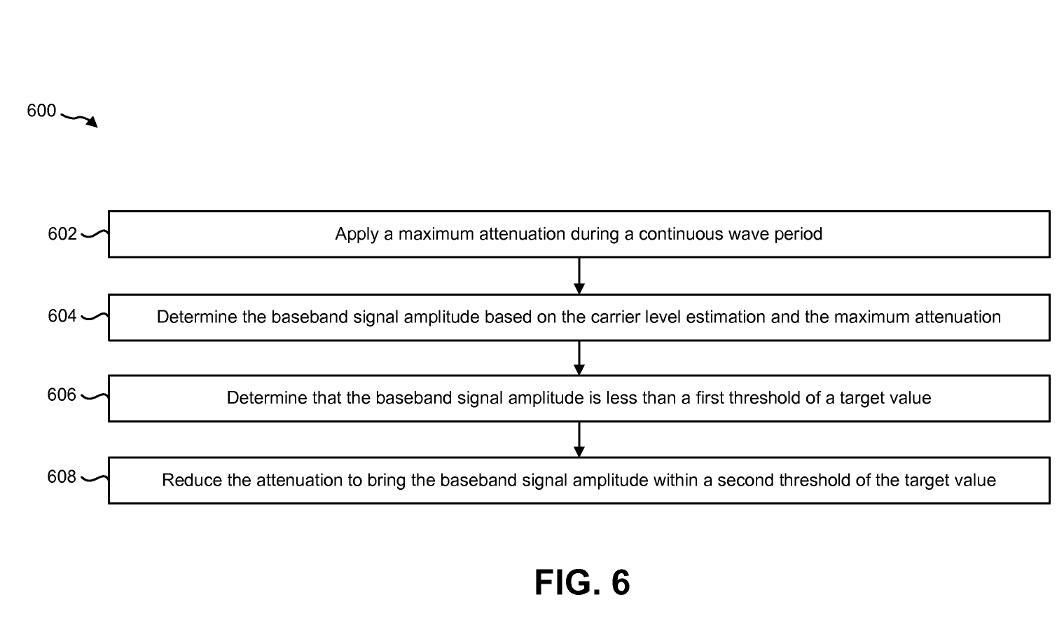

FIG. 6 is a flow diagram illustrating a method 600 for dynamically adjusting attenuation 114 using a carrier estimation path 112. The method 600 may be performed by an initiator NFC device 102 during normal operation of the initiator receiver 104. For example, the initiator NFC device 102 may be communicating with a target NFC device 139.

The initiator NFC device 102 may receive a carrier signal 108. The initiator NFC device 102 may enable the carrier estimation path 112 during a continuous wave period. The carrier estimation path 112 may bypass the BPF 378 of the initiator receiver 104. In one case, the continuous wave period may include the initial initiator transmission of the continuous wave to the target NFC device 139 (before the target NFC device 139 modulates the continuous wave). Another continuous wave period may include the transition from initiator transmission to initiator reception.

The initiator NFC device 102 may apply 602 a maximum attenuation 114 during the continuous wave period. The maximum attenuation 114 may be the maximum attenuation 114 in an AGC gain table 126. For example, the maximum attenuation 114 may correspond to a maximum attenuator code in the AGC gain table 126. The maximum attenuation 114 may ensure that the initiator receiver 104 is not saturated by the carrier signal 108.

The initiator NFC device 102 may determine 604 a baseband signal amplitude 134 based on the carrier level estimation 122 and the maximum attenuation 114. While the maximum attenuation 114 is applied, the initiator NFC device 102 may convert the analog carrier signal 108 to a DC level. The DC level may include an in-phase component and a quadrature-phase component. The DC level may be converted to a digital signal. The initiator NFC device 102 may perform the carrier level estimation 122 by measuring the DC level of the in-phase channel (I_{dc}) and the quadrature-phase channel (Q_{dc}). The initiator NFC device 102 may determine the baseband signal amplitude (A_{bb}) 134 according to Equation (2).

The initiator NFC device 102 may determine 606 that the baseband signal amplitude (A_{bb}) 134 is less than a target value 136. If the baseband signal amplitude 134 is much less than the target value 136, then the initiator NFC device 102 may reduce 608 the attenuation 114 to bring the baseband signal amplitude 134 within a threshold of the target value 136. For example, the initiator NFC device 102 may determine whether the baseband signal amplitude 134 is less than the target value 136 by a first threshold of the target value 136. If the baseband signal amplitude 134 is less than this first threshold, then the initiator NFC device 102 may reduce 608 the attenuation 114 to bring the baseband signal amplitude 134 within a second threshold of the target value 136.

It should be noted that the method 600 involves a one-point dynamic AGC procedure. In other words, the attenuation 114 is adjusted based on a single carrier level estimation. This reduces the amount of time for adjusting the initiator receiver 104 gain. Other search algorithms (e.g., a binary search) may require more measurements, which may slow down calibration and reduce efficiency.

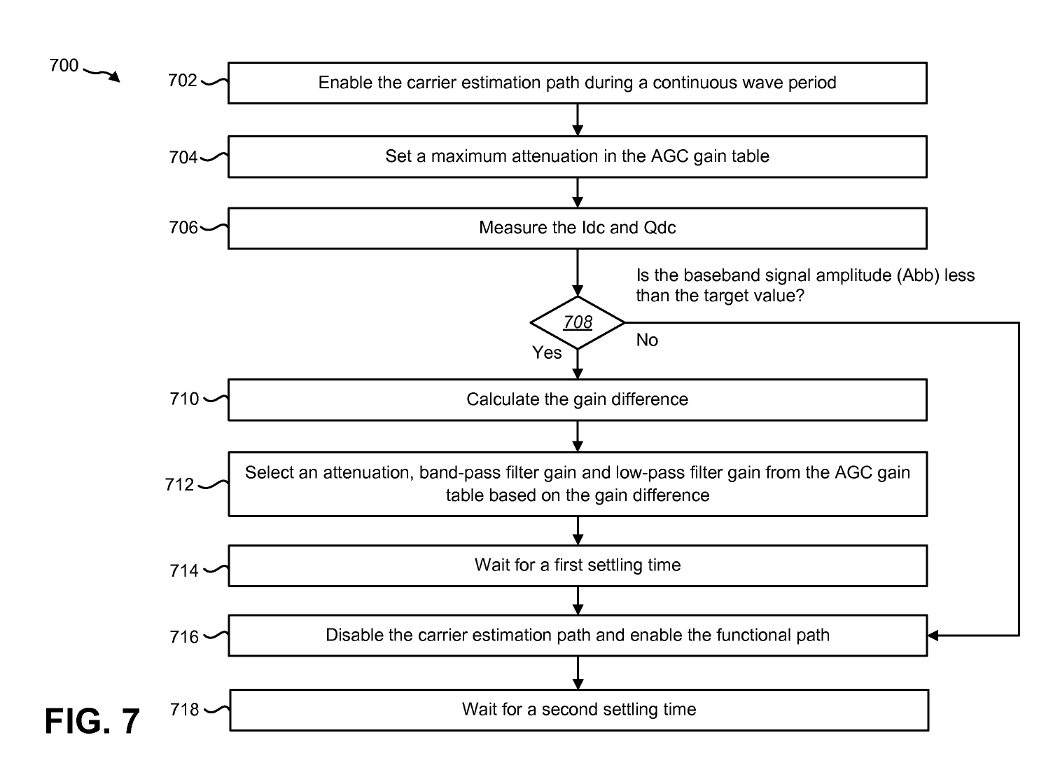

FIG. 7 is a flow diagram illustrating a detailed method 700 for dynamically adjusting attenuation 114 using a carrier estimation path 112. The method 700 may be performed by an initiator NFC device 102 during normal operation of the initiator receiver 104. For example, the initiator NFC device 102 may be communicating with a target NFC device 139. The initiator NFC device 102 may receive a carrier signal 108.

The initiator NFC device 102 may enable 702 a carrier estimation path 112 during a continuous wave period. The carrier estimation path 112 may preserve a carrier signal 108 by bypassing a band-pass filter 378.

The initiator NFC device 102 may set 704 the maximum attenuation 114 in an AGC gain table 126. For example, the initiator NFC device 102 may set 704 the attenuation 114 of the attenuator 374 to the first entry in the AGC gain table 126. In one configuration, the AGC gain table 126 may be a LUT.

The initiator NFC device 102 may measure 706 the I_{dc} and the Q_{dc}. The initiator NFC device 102 may convert the analog carrier signal 108 to a DC level that includes an in-phase channel (I_{dc}) and a quadrature-phase channel (Q_{dc}). In one configuration, the initiator NFC device 102 may convert the DC level to a digital signal and then measure 706 the I_{dc} and the Q_{dc}.

The initiator NFC device 102 may determine 708 whether a baseband signal amplitude (A_{bb}) 134 is less than a target value (Vref) 136. A_{bb} 134 may be determined according to Equation (2). If A_{bb} 134 is less than the target value 136, the initiator NFC device 102 may calculate 710 a gain difference (G_{d}). This may be accomplished according to Equation (3).

G_{d}=20·log 10(0.5/A_{bb}) (3)

The initiator NFC device 102 may select 712 an attenuation 114, BPF gain 116, LPF gain 118 from the AGC gain table 126 based on the gain difference (G_{d}). In one implementation, the initiator NFC device 102 may jump to entry [1+floor(G_{d}/2)] in the AGC gain table 126. This equation assumes a 2 dB step in attenuation gain 130 and may be modified for other step sizes. This AGC gain table 126 entry may bring A_{bb} 134 within a threshold of the target value 136.

The initiator NFC device 102 may wait 714 for a first settling time. The initiator NFC device 102 may then disable 716 the carrier estimation path 112, enable the functional path 110 and may wait 718 for a second settling time before continuing normal operations.

If the initiator NFC device 102 determines 708 that A_{bb} 134 is not less than the target value 136, the initiator NFC device 102 may disable 716 the carrier estimation path 112 and enable the functional path 110. In this case, the initiator NFC device 102 does not adjust the attenuation 114. The initiator NFC device 102 may then wait 718 for the second settling time before continuing normal operations.

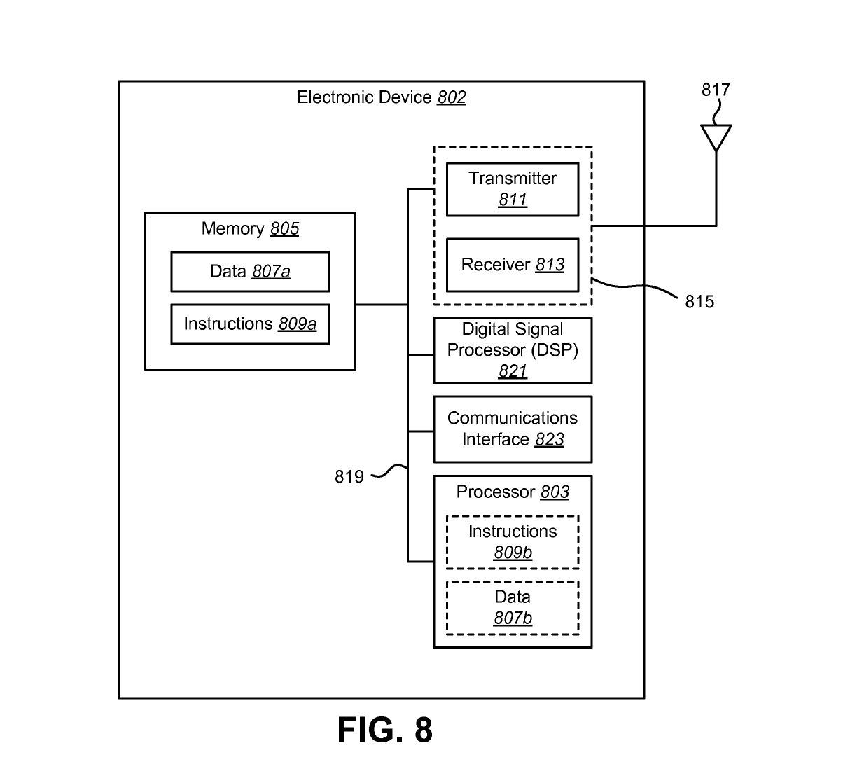

FIG. 8 illustrates certain components that may be included within an electronic device 802. The electronic device 802 may be an access terminal, a mobile station, a user equipment (UE), etc. For example, the electronic device 802 may be the initiator NFC device 102 of FIG. 1.

The electronic device 802 includes a processor 803. The processor 803 may be a general purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 803 may be referred to as a central processing unit (CPU). Although just a single processor 803 is shown in the electronic device 802 of FIG. 8, in an alternative configuration, a combination of processors (e.g., an ARM and DSP) could be used.

The electronic device 802 also includes memory 805 in electronic communication with the processor (i.e., the processor can read information from and/or write information to the memory). The memory 805 may be any electronic component capable of storing electronic information. The memory 805 may be configured as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 807a and instructions 809a may be stored in the memory 805. The instructions may include one or more programs, routines, sub-routines, functions, procedures, code, etc. The instructions may include a single computer-readable statement or many computer-readable statements. The instructions 809a may be executable by the processor 803 to implement the methods disclosed herein. Executing the instructions 809a may involve the use of the data 807a that is stored in the memory 805. When the processor 803 executes the instructions 809, various portions of the instructions 809b may be loaded onto the processor 803, and various pieces of data 807b may be loaded onto the processor 803.

The electronic device 802 may also include a transmitter 811 and a receiver 813 to allow transmission and reception of signals to and from the electronic device 802 via an antenna 817. The transmitter 811 and receiver 813 may be collectively referred to as a transceiver 815. The electronic device 802 may also include (not shown) multiple transmitters, multiple antennas, multiple receivers and/or multiple transceivers.

The electronic device 802 may include a digital signal processor (DSP) 821. The electronic device 802 may also include a communications interface 823. The communications interface 823 may allow a user to interact with the electronic device 802.

The various components of the electronic device 802 may be coupled together by one or more buses, which may include a power bus, a control signal bus, a status signal bus, a data bus, etc. For the sake of clarity, the various buses are illustrated in FIG. 8 as a bus system 819.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 2, and FIGS. 4-7, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. A method, comprising:
determining a carrier level estimation of a carrier signal received by a communication device using a carrier estimation path; and
adjusting an attenuation based on the carrier level estimation.

2. The method of claim 1, further comprising adjusting at least one of a band-pass filter gain and a low-pass filter gain based on the carrier level estimation.

3. The method of claim 1, carrier estimation path is included in a receiver.

4. The method of claim 1, wherein the communication device is an initiator near field communication (NFC) device.

5. The method of claim 1, wherein the carrier estimation path preserves the carrier signal by bypassing a band-pass filter.

6. The method of claim 1, wherein the carrier level estimation is determined during a continuous wave period.

7. The method of claim 1, wherein determining the carrier level estimation comprises:
enabling the carrier estimation path;
receiving the carrier signal at the carrier estimation path;
converting the carrier signal to a DC level, wherein the DC level comprises an in-phase component and a quadrature-phase component; and
measuring the DC level.

8. The method of claim 1, further comprising determining an automatic gain control (AGC) gain table based on the carrier level estimation.

9. The method of claim 8, wherein determining the AGC gain table comprises:
applying a range of attenuation values;
determining an attenuator gain for each attenuation value based on the carrier level estimation;
selecting attenuation values to produce nominal steps within an attenuation gain range; and
assigning the selected attenuation values to index numbers of the AGC gain table.

10. The method of claim 1, wherein adjusting the attenuation comprises:
determining a baseband signal amplitude based on the carrier level estimation; and
determining whether to reduce the attenuation based on whether the baseband signal amplitude is less than a target value.

11. The method of claim 10, wherein adjusting the attenuation further comprises:
applying a maximum attenuation during a continuous wave period;
determining the baseband signal amplitude based on the carrier level estimation and the maximum attenuation;
determining that the baseband signal amplitude is less than a target value; and
reducing the attenuation to bring the baseband signal amplitude within a threshold of the target value.

12. An electronic device, comprising:
a processor;
memory in electronic communication with the processor; and
instructions stored in the memory, the instructions being executable by the processor to:
determine a carrier level estimation of a carrier signal received by the electronic device using a carrier estimation path; and
adjust an attenuation based on the carrier level estimation.

13. The electronic device of claim 12, further comprising instructions executable to adjust at least one of a band-pass filter gain and a low-pass filter gain based on the carrier level estimation.

14. The electronic device of claim 12, further comprising instructions executable to:
apply a range of attenuation values;
determine an attenuator gain for each attenuation value based on the carrier level estimation;
select attenuation values to produce nominal steps within an attenuation gain range; and
assign the selected attenuation values to index numbers of an AGC gain table.

15. The electronic device of claim 12, wherein the instructions executable to adjust the attenuation comprise instructions executable to:
determine a baseband signal amplitude based on the carrier level estimation; and
determine whether to reduce the attenuation based on whether the baseband signal amplitude is less than a target value.

16. The electronic device of claim 15, wherein the instructions executable to adjust the attenuation further comprise instructions executable to:
apply a maximum attenuation during a continuous wave period;
determine the baseband signal amplitude based on the carrier level estimation and the maximum attenuation;
determine that the baseband signal amplitude is less than a target value; and
reduce the attenuation to bring the baseband signal amplitude within a threshold of the target value.

17. A computer-program product, the computer-program product comprising a non-transitory computer-readable medium having instructions thereon, the instructions comprising:
code for causing an electronic device to determine a carrier level estimation of a carrier signal received by the electronic device using a carrier estimation path; and
code for causing the electronic device to adjust an attenuation based on the carrier level estimation.

18. The computer-program product of claim 17, further comprising code for causing the electronic device to adjust at least one of a band-pass filter gain and a low-pass filter gain based on the carrier level estimation.

19. The computer-program product of claim 17, further comprising:
code for causing the electronic device to apply a range of attenuation values;
code for causing the electronic device to determine an attenuator gain for each attenuation value based on the carrier level estimation;
code for causing the electronic device to select attenuation values to produce nominal steps within an attenuation gain range; and
code for causing the electronic device to assign the selected attenuation values to index numbers of an AGC gain table.

20. The computer-program product of claim 17, wherein the code for causing the electronic device to adjust the attenuation comprises:
code for causing the electronic device to determine a baseband signal amplitude based on the carrier level estimation; and
code for causing the electronic device to determine whether to reduce the attenuation based on whether the baseband signal amplitude is less than a target value.
